(19) United States
(12) Patent Application Publication
(10) Pub. No.: US 2023/0351341 A1
(43) Pub. Date: Nov. 2, 2023

(54) Non-Fungible Tokens (NFTs) Pay Passive Income

(71) Applicant: Philip Scott Lyren, Wadsworth, OH (US)

(72) Inventor: Philip Scott Lyren, Wadsworth, OH (US)

(21) Appl. No.: 17/731,658

(22) Filed: Apr. 28, 2022

(51) Int. Cl. G06Q 20/06; G06Q 20/10; H04L 9/00

(52) U.S. Cl. CPC G06Q 20/065; G06Q 20/108; H04L 9/50; H04L 2209/56; G06Q 2220/00

(57) ABSTRACT

Methods and apparatus provide passive income to sellers and buyers of non-fungible tokens (NFTs). A seller sells the NFTs to buyers, and cryptocurrency from the sale of the NFTs is provided to a pool. The pool generates income from this cryptocurrency and pays this income as passive income to the sellers and buyers of the NFTs.

### BACKGROUND

Blockchains provide a structure to store digital assets and crypto tokens. Various technical challenges, however, exist with regard to how blockchains can store digital assets and crypto tokens while enabling them to provide income to their owners.

Example embodiments offer solutions to some of these challenges and assist in providing technological advancements in methods and apparatus that pay income to owners of digital assets and crypto tokens stored on blockchains.

### BRIEF DESCRIPTION OF THE DRAWINGS

FIG. 1 is a method to distribute passive income generated from a pool between sellers of digital assets and buyers of the digital assets in accordance with an example embodiment.

FIG. 2 is a method to increment the price of a digital asset after each sale in accordance with an example embodiment.

FIG. 3 is a method that provides time periods for buying and/or selling a digital asset in accordance with an example embodiment.

FIG. 4 is an electronic or computer system in accordance with an example embodiment.

### SUMMARY

Example embodiments include methods and apparatus that provide digital assets on a blockchain that pay passive income to sellers and/or buyers of the digital assets.

In one example embodiment, a seller sells an NFT to a buyer, and cryptocurrency from the sale of this NFT goes into a pool. The pool generates income from this cryptocurrency and pays this income as passive income to seller of the NFT and to the buyer of the NFT.

Other example embodiments are discussed herein.

### DETAILED DESCRIPTION

One or more example embodiments in accordance with the invention include methods and apparatus that pay passive income to buyers and/or sellers of digital assets and/or cryptographic tokens stored on blockchains.

Non-fungible tokens or NFTs have exploded in popularity as a way for people to buy, sell, and trade digital assets stored on a blockchain. The blockchain includes a digital ledger that uniquely identifies each NFT and provides the public with a way to certify authenticity and proof of ownership. For example, once an asset such as a picture, text, a video, film/movie, song, game, software application, asset from game, broadcast or streaming event, music, artwork, or a voice recording is in digital format, the digital asset can be minted into an NFT on a blockchain and then sold or traded on an electronic marketplace, website, or virtual world.

Although NFTs provide people with a great way to sell digital assets, they have various problems rooted in the technology of the blockchain, electronic marketplaces, and structure of how NFTs are created, bought, and sold.

One significant problem is buyers of NFTs only receive profit from the NFT if it is sold after appreciating in value. For example, an artist creates a piece of digital art and sells this art to a buyer as an NFT for $100. In order for the buyer to make a profit, he or she must sell the NFT for more than $100. The value of the NFT needs to appreciate for the buyer to make money. Other than appreciation of the underlying digital asset, the buyer does not have an alternative way to make money with the NFT.

Flipping is another problem that causes the value of the NFT to decrease in value, which deters buyers from buying and holding NFTs. Flipping NFTs refers to buying an NFT at a low price and then quickly selling the NFT for a higher price to realize a profit. This process leads to market volatility as prices for NFTs can fluctuate wildly as people buy and quickly sell NFTs as opposed to buy and hold the NFTs for a period of time, such as weeks, months, or years.

Consider the following example showing how flipping NFTs depreciates their value. An artist designs some artwork and plans to sell 1000 unique versions of this artwork as NFTs in a collection at an electronic marketplace, such as the OpenSea marketplace on the Ethereum blockchain, the JPG store marketplace on the Cardano blockchain, or the MagicEden marketplace on the Solana blockchain. The artist sets a minimum or floor price at the electronic marketplace of $10 for each NFT in the collection. Buyers navigate to the electronic marketplace and pay $10 to mint or buy a unique NFT. While the NFTs in the collection are being minted and sold or shortly thereafter, some buyers (known as NFT flippers) immediately offer them for sale on a secondary electronic marketplace. The idea is to flip or sell the NFT and make a quick profit.

Flipping the NFTs, however, creates a surplus in the market and causes the price of the NFTs to go down. Flippers of NFTs generally have no financial incentive in holding the NFTs long term. If the NFT cannot be immediately sold for a quick profit, then the flipper of the NFT will sell at a loss. Selling for a loss, in turn, causes the value of the remaining NFTs to depreciate. This depreciation is especially harmful to buyers who bought as long-term holders or buyers hoping to have financial gain through appreciation over an extended period of time.

Since NFTs are minted to a blockchain and the ledgers are public, buyers and sellers can readily see historical price and sale information for each NFT, such as when it was bought/sold and for how much. This information forms part of the public record for each NFT and is easily available to buyers and sellers. These facts can further lead to flippers engaging in frenzy buying and selling of NFTs as the prices are available in real-time, which in turn leads to highly volatile markets for NFTs.

Example embodiments include several mechanisms to solve these problems inherent in conventional NFTs and methods for selling them. These example embodiments reduce market volatility, decrease large price fluctuations for buyers and sellers of NFTs, and provide a greater financial incentive for buyers to buy and hold NFTs, as opposed to buy and flip NFTs. Even though many examples are provided with regard to NFTs, example embodiments apply to various other types of digital assets as well.

One example embodiment pays owners of an NFT a fixed or variable rate of return for holding the NFT. The example embodiment generates these payments from one or more pools, such as a liquidity pool, staking, borrowing and/or lending pool, or another income generating source discussed herein. Payments to the buyers and/or sellers of the NFTs are continually or periodically made on a time basis, such as hourly, daily, weekly, monthly, or yearly. These payments are passive income to the buyers and/or sellers of the NFTs and provide the buyers with an incentive to buy and hold the NFTs, as opposed to buy and flip the NFTs.

One example embodiment sets limits that govern the NFT, such as governing the sale, purchase, reproduction, lifetime, and/or distribution of the NFT. For example, an embodiment sets these limits in code of a smart contract that governs the NFT. Further examples of these limits include, but are not limited to, one or more of how much a person or entity can buy or sell an NFT, when an owner can sell an NFT after purchasing it, how long an owner must hold the NFT before selling it, how many copies of the NFT can be made and/or sold, and how much profit or loss the owner can receive for selling an NFT.

One example embodiment distributes profit from the sale of an NFT to previous owners of the NFT. Distribution of profit in this manner ensures that profit spreads around to several people or entities, as opposed to all profit going to a single seller or owner of the NFT.

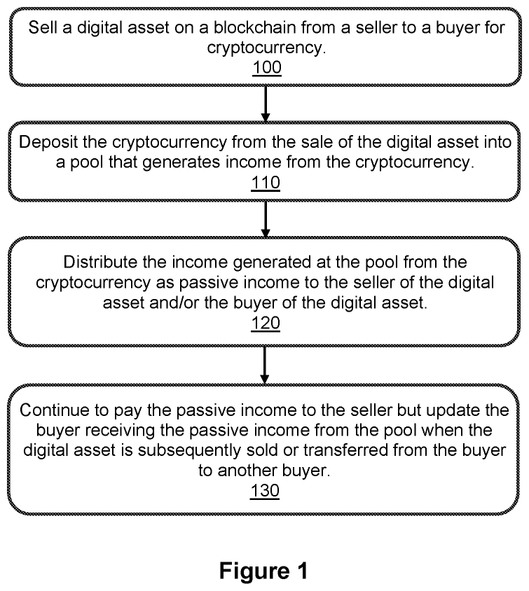

FIG. 1 is a method to distribute passive income generated from a pool between sellers of digital assets and buyers of the digital assets in accordance with an example embodiment.

Block 100 states sell a digital asset on a blockchain from a seller to a buyer for cryptocurrency.

Cryptocurrency is a digital currency or tradeable digital asset that functions as a medium of exchange through a computer network, such as a blockchain. Examples of cryptocurrency include, but are not limited to, fungible tokens, NFTs, stablecoins, altcoins, coins, and other digital assets. For instance, cryptocurrencies include bitcoin (BTC), dogecoin (DOGE), ether (ETH), USD coin (USDC), Dai stablecoin (DAI), USD tether (USDT), virtual land or stores (such as stores or plots of land on Sandbox, Decentraland, or a Metaverse platform), a Central Bank Digital Currency (CBDC), and any one of the thousands of coins and altcoins on various blockchains.

The sale can transfer all right, title, and interest of the digital asset from the seller to the buyer. Alternatively, the sale can transfer a portion of this right, title, and interest, such as renting or leasing the digital asset for a given period of time or selling the digital asset to a buyer with restrictions or limits on the digital asset. Further, the buyer of the digital asset can maintain a right to receive income (such as passive income) generated from the cryptocurrency used to buy the digital asset from the seller.

Consider an example in which a seller designs a digital asset, such as piece of art, video, music, or virtual land. The seller then offers this digital asset for sale as an NFT, such as offering the NFT for sale at a website on the internet, an electronic marketplace, an NFT marketplace, a virtual world browser-based platform, a virtual store, or other place where virtual goods or digital assets are sold. A buyer purchases the NFT from the seller in exchange for an amount of cryptocurrency, another NFT, or other digital asset.

Consider an example in which an artist designs hundreds or thousands of NFTs as a collection. The artist offers these NFTs for sale at a marketplace (such as OpenSea, Rarible, Binance NFT, MagicEden, Holaplex, etc.) or another website (such as the artist's website that includes software for generating and/or minting NFTs to a blockchain). Buyers navigate to the marketplace or website and buy the NFTs with one or more cryptocurrencies.

The seller can be a creator or first owner of the digital asset. Alternatively, the seller purchases or acquires the digital asset from another person, party, or entity.

Block 110 states deposit the cryptocurrency from the sale of the digital asset into a pool that generates income from the cryptocurrency.

Cryptocurrency from the sale or loan of the digital asset is deposited, listed, staked, loaned, transferred, or provided into one or more pools built on a blockchain and governed with one or more smart contracts. Example embodiments include different types of pools, such as a staking pool, a lending pool, a liquidity pool, an NFT pool, and other types of pools. By way of example, pools can exist as part of a centralized exchange, a decentralized exchange, or a full or partial decentralized autonomous organization (DAO).

A staking pool is a pool of cryptocurrency available on blockchains that utilize proof of stake (PoS) which is a consensus mechanism for processing transactions and creating new blocks in a blockchain. For example, stakeholders or users giving money to the pool lock their cryptocurrency in the pool for a specific period of time in return for a fee or reward, such as a percentage of the transaction fees other users pay miners or nodes to process transactions on the blockchain. Stakeholders receive the reward in a cryptocurrency as passive income without being involved in the technical implementation of the staking pool, setting up and running a validating node, etc.

A lending pool is a pool of cryptocurrency available on blockchains for users to borrow. Borrowers pay a fee and/or interest for cryptocurrency borrowed from the pool. These fees and/or interest are then paid as passive income to the lenders of the cryptocurrency.

A liquidity pool is a pool of cryptocurrency used to facilitate trades or swaps between different cryptocurrencies on a centralized exchange (CEX) or a decentralized exchange (DEX). Users (called liquidity providers or LPs) deposit pairs of cryptocurrencies into a pool to create a market where other uses can exchange, trade, or swap one cryptocurrency for another cryptocurrency in exchange for paying a fee. The pool pays the fees from these swaps to the liquidity providers as passive income.

An NFT pool is a pool of NFTs that are loaned out to users in exchange for a fee that is paid back to the owner of the NFT. For example, a buyer, creator, or owner of an NFT loans her NFT to the pool. Other users receive temporary, partial, or permanent ownership in the NFT or a derivative of this NFT and pay a fee for this right.

Block 120 states distribute the income generated at the pool from the cryptocurrency as passive income to the seller of the digital asset and/or the buyer of the digital asset.

The pool generates income and then distributes this income as passive income to the seller of the digital asset, the buyer of the digital asset, or both the buyer and the seller of the digital asset. Sellers include the owners or creators who originally or first owned or created the digital assets and who own the cryptocurrency received for the sale of the digital asset. Buyers include people or entities that buy from the owners or creators or subsequent buyers (e.g., when the digital asset is sold from a first buyer to a second buyer).

The method described herein of sharing passive income between the seller and buyers is financially counterintuitive and against conventional methods. Why would a seller create and sell digital assets and then provide the cryptocurrency from the sale of these digital assets into a pool that pays passive income to the buyers?

Methods of example embodiments are quite unconventional and contradictory to known financial methods to generate income for the seller. These embodiments solve problems with prior sales of digital assets on a blockchain, such as wild price fluctuations of the digital assets, flipping of the digital assets, price depreciation of the digital assets, lack of passive income from the digital assets, and other problems.

Methods described herein are financially beneficial to both the user or seller selling the digital assets (e.g., original or first owner or creator) and the user or buyers buying the digital assets. For example, in one example embodiment, income generated from the lending pool is shared between the seller and buyers of the digital assets. This distribution of income provides passive income to both the buyer and seller and provides an incentive to the buyer to hold the digital asset, instead of flipping or selling the digital asset. The buyer owns the digital asset, while the seller owns the cryptocurrency received from the sale of the digital asset. Both the seller and the buyers benefit from the sale since they both receive passive income generated from the purchase price of the digital asset. Further, the seller benefits because buyers will hold the digital asset long term in order to receive the passive income. This will create price stability of the digital asset and reduce the probability of depreciation of the digital asset.

After the sale of the digital assets, the seller maintains ownership of the money (cryptocurrency) in the lending pool generated from the sale, and the buyers maintain ownership of the digital assets purchased from the sale. The seller and buyers, however, share income generated from the lending pool. For instance, buyers receive a percentage of this income, such as receiving 10%, 20%, 30%, 40%, 50%, 60%, 70%, 80%, or 90%, while the seller receives the remaining percentage. For instance, buyers and sellers share income generated from the lending pool as a percentage or ratio of the gross income or net income, such 90% to sellers and 10% to buyers, 80% to sellers and 20% to buyers, 70% to sellers and 30% to buyers, 60% to sellers and 40% to buyers, 50% to sellers and 50% to buyers, 40% to sellers and 60% to buyers, 30% to sellers and 70% to buyers, 20% to sellers and 80% to buyers, or 10% to sellers and 90% to buyers.

Code in smart contracts executes to govern the underlying protocol of the pools, such as borrowing, lending, swapping, paying of the cryptocurrency, collection of fees, etc. This code also governs the distribution of the passive income to the sellers and buyers. These protocols are fully or partially automated and execute with little or no governance, such as a fully or partially decentralized autonomous organization (DAO).

Consider an example of a user (e.g., a company, a person, or a software program) creates a collection of ten thousand unique NFTs that are pictures or artwork people buy as profile pictures or avatars. The user sells each one of these NFTs on the Cardano blockchain for one hundred ADA, which is the primary cryptocurrency of Cardano. At the time of the sale, one ADA sells for one US dollar, so the sale of the ten thousand NFTs generated one million ADA or one million dollars. The code or protocol executing the sale of the NFT automatically deposits or transfers the one million ADA into a decentralized, autonomous lending pool that executes through smart contracts on the Cardano blockchain. These deposits into the lending pool automatically occur in response to an NFT being sold to a buyer.

Borrowers come to the lending pool, deposit a cryptocurrency as collateral, and borrow ADA or another cryptocurrency from the lending pool. The borrowers pay a transaction fee to the lending pool for executing their borrows, or pay a transaction fee for swapping their cryptocurrency for ADA from the pool. When the borrowers return the borrowed ADA back to the lending pool, the borrowers receive back their collateral and pay a fee for borrowing the ADA, such as paying an interest rate of an annual percentage yield (APY) or annual percentage rate (APR). The code or protocol executing the lending pool pays the transactions fees and/or the interest rates back to the sellers and buyers of the NFTs. In this way, the buyers of the NFTs receive a periodic, continuous, or continual stream of passive income as long they own the NFTs, while the seller continue to receive the passive income whether the buyers hold or sell the NFTs. Payments from lending pool are made in ADA to the Cardano blockchain address registered to the sellers and the buyers of the NFT.

Consider an example in which an artist or person creates a unique virtual store for selling virtual goods and/or services. The store includes a storefront and a unique interior design for selling goods/services to users in a virtual environment or augmented world, such as an augmented reality (AR) world, a virtual reality (VR) world, or the metaverse. The store has distinct and/or unique characteristics that signify the source of the products to consumers in a manner of a trade dress which the artist desires to sell as an NFT. The artist lists this NFT for sale on an electronic marketplace. Other users purchase this NFT and setup a franchise or similar looking store to sell their goods and/or services. Customers recognize the trade dress of these stores while virtual shopping. In addition to the fee for selling the NFT store, the artist receives a passive income from the purchasers of the NFT. For example, purchasers of the NFT pay this passive income as a flat fee (such as an hourly fee, a daily fee, a weekly fee, or a monthly fee) or a variable fee (such as a fee based on a percentage of sales at the virtual store).

Consider an example in which a user plays a play-to-earn (P2E) crypto game that includes earning cryptocurrency by playing the game. The user carries out quests, wins battles, and completes challenges in exchange for cryptocurrency and/or NFTs. Some of these NFTs are difficult to obtain and require hundreds of hours of game play to acquire. Other users desire to have these NFTs but lack the time or skill to obtain them. The user places these NFTs for sale in a pool where other users can bid and buy the NFTs and then use the purchased NFTs in the P2E crypto game. These users are thus able to acquire the NFT without having to spend the countless hours of game play. Income generated from these purchases transfers to a cryptocurrency lending pool and/or swapping pool, and income earned from this money at the pool is paid to the players who earned or won the NFTs and the buyers who bought the NFTs from these players.

Consider an example in which a creator (e.g., a person, a group of people, a computer program, or an entity) creates a one or more digital assets and sells the digital assets at an electronic marketplace, such as Opensea. Information concerning the sales records to a blockchain when the sales occur as ownership of the digital assets transfers from the creator to the buyers. When a sale occurs, cryptocurrency used to purchase the digital asset automatically transfers to a crypto pool that generates income. The blockchain records the creator as the owner of the cryptocurrency used to purchase the digital assets and records the buyers as the owners of the digital assets. Code in smart contracts executes to distribute income from the pool to both the creator and the buyers of the digital asset.

Block 130 continue to pay the passive income to the seller but update the buyer receiving the passive income from the pool when the digital asset is subsequently sold or transferred from the buyer to another buyer.

When a buyer purchases the digital asset from the owner, both the buyer and the owner receive passive income generated from the pool. Distribution of this passive income to the buyer ceases when the buyer subsequently sells or transfers ownership of the digital asset. This provides a financial incentive to the buyer to hold and not sell the digital asset. Distribution of this passive income, however, continues to be paid to the seller even after the buyer sells the digital asset. The seller continues to receive the passive income as long as the cryptocurrency from the sale remains in the pool. When the cryptocurrency releases or returns back to the seller, passive income to the seller and buyer ceases.

Income from the sale of the cryptocurrency can stay in the pool for a predetermined amount of time or other time, such as a time decided by the seller. For example, this period of time is set or written in the smart contract and known or publicly available so buyers know how long they will receive the passive income. Writing this time into the smart contract further prevents the seller from prematurely removing the cryptocurrency from the pool.

Consider an example in which a player wins or earns a digital asset in a play-to-earn crypto game. The player sells this digital asset as an NFT to a first buyer. A blockchain records the sale from the player to the first buyer, and the cryptocurrency used to purchase the digital asset transfers to a pool for one year.

After expiration of one year, the cryptocurrency automatically returns to the player. During the one year period, the pool generates income from this cryptocurrency and distributes this income as passive income to both the player and the first buyer. The first buyer uses the digital asset in the play-to-earn crypto game and receives the passive income. Thereafter, the first buyer sells the digital asset to a second buyer who desires to use the digital asset in the play-to-earn crypto game. Ownership and sale of the digital asset records on the blockchain. Thereafter, the first buyer no longer receives the passive income because this passive income is now paid to the second buyer who is the recorded new owner of the digital asset. The player continues to receive his or her portion of the passive income because the player was the original creator or owner of the digital asset and owner of the cryptocurrency in the pool from the original sale of the digital asset.

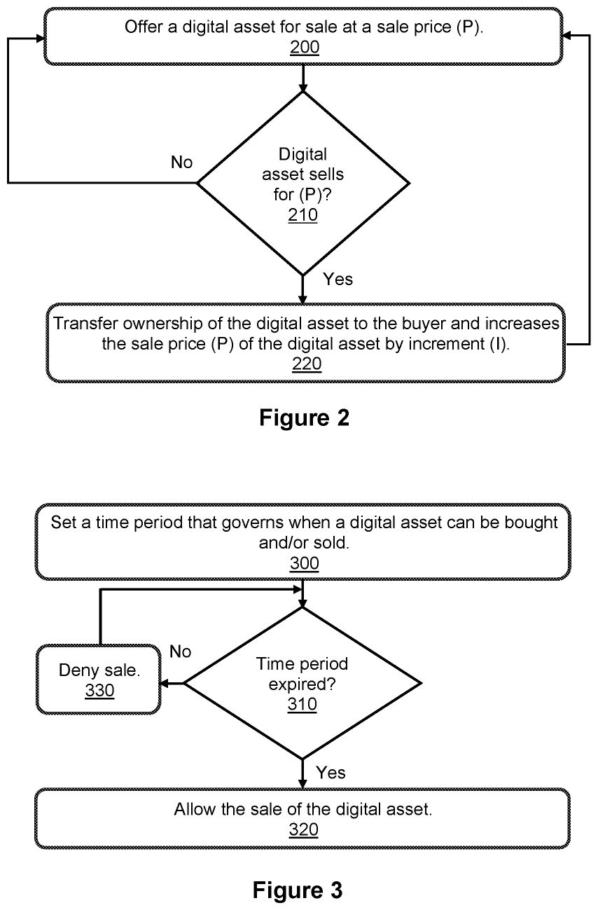

FIG. 2 is a method to increment the price of a digital asset after each sale in accordance with an example embodiment.

Block 200 states offer a digital asset for sale at a sale price (P).

Consider an example in which an owner or creator of a digital asset sets an initial price a buyer must pay in a cryptocurrency to buy the digital asset at an electronic marketplace. This sale price (P) can be a minimum price (e.g., the purchase price ≥P) or a fixed price (e.g., the purchase price=P). The price and its condition, such as being a minimum price or a fixed price, are coded into a smart contract that executes on the blockchain where the digital asset resides.

Block 210 makes a determination as to whether the digital asset sells for the sale price (P).

If the answer to this determination is no, flow proceeds back to block 200. The price of the digital asset remains at P.

If the answer to this determination is yes, flow proceeds to block 220 which states transfer ownership of the digital asset to the buyer and automatically increases the sale price (P) of the digital asset by increment (I).

Flow proceeds back to block 200 where the sale price (P) of the digital asset is the previous sale price plus the increment. The increment (I) includes fixed amounts and/or variable amounts. These amounts include fixed amounts, preset amounts, predetermined amounts, amounts based on a fixed increment, amounts based on a variable increment, a percentage of a previous sale price, a percentage of an initial or first sale price, a multiplier, etc. Setting these amounts prevents wild price fluctuations in the sale of digital assets and stabilizes the price.

For example, the sale price (P) automatically increases by a fixed, preset, or predetermined amount of cryptocurrency on each sale. For instance, the sale price (P) is set to 1 ETH, and the increment (I) is set to 0.1 ETH. The digital asset mints and has a first sale for 1.0 ETH; the next sale occurs at 1.1 ETH; the next sale occurs at 1.2 ETH, etc. Each subsequent sale increases by a fixed amount of 0.1 ETH. These prices are set in code of the smart contract, automatically execute, and cannot subsequently be altered or changed.

For example, the sale price (P) increases by a fixed percentage which results in a variable amount of cryptocurrency on each sale. For instance, the sale price (P) is set to 100 DOGE, and the increment (I) is set to 10% of the previous sale price. The digital asset mints and has a first sale for 100 DOGE. This sale automatically sets the sale price on the next sale to:

P+(P×10%)=100+(100×0.10)=110 DOGE.

The next sale price would automatically set to:

P+(P×10%)=110+(110×0.10)=121 DOGE.

This process cycles and continues each time the digital asset sells.

In an example embodiment, the sale price (P) and increments (I) are coded into one or more smart contracts that govern the price and sale for the digital asset. The code in the smart contracts makes these prices immutable or unchangeable. Alternatively, the code in the smart contract enables subsequent owners to change the prices.

Consider an example in which a creator of a digital asset sets an initial sale price and sets subsequent sale prices or increments for all future or subsequent sales of the digital asset. These prices are immutably coded into the smart contract such that subsequent buyers and sellers of the digital asset are bound to these prices. Coding the prices into the smart contract in this manner eliminates price volatility of the digital asset since the sales price cannot vary from what is coded into the smart contract. This enables a buyer to know in advance how much he or she can sell the digital asset in the future and hence know in advance how much profit or loss will occur with a subsequent sale.

Consider an example in which the creator or first owner of the digital asset sets prices that include increasing and/or decreasing increments for future sales of the digital asset. For example, the owner sets an initial price of the digital asset at 100 USDC and then sets each subsequent sale price to increment by 10 USDC. The owner also sets increment decreases in price at 10 USDC. Prices for all subsequent sales of the digital asset are thus set before these subsequent sales occur. In this example, the price of the digital asset is fixed to increase or decrease in increments of 10 USDC on each sale. These increments also prevent a buyer from losing or gaining a large percentage of money on a subsequent sale since the maximum amount of money that can be made or lost is 10 USDC.

An example embodiment sets or fixes the sale price, increments, minimum price, maximum price, and/or other prices for the digital asset. These prices are set at one of various times, such as setting the prices when the digital asset is created, setting the prices after the digital asset is created but before the digital asset is first sold, setting the prices when the digital asset is sold, setting the prices after the digital asset is sold, or setting the prices when the digital asset is minted.

These prices and increments are in the smart contract and thus available to the public. In this way, buyers and sellers can readily see the prices and increments before buying and/or selling the digital assets.

FIG. 3 is a method that provides time periods for buying and/or selling a digital asset in accordance with an example embodiment.

Block 300 states set a time period that governs when a digital asset can be bought and/or sold.

Consider an example in which an owner or creator of a digital asset sets a period of time that governs when the digital asset can be bought and/or sold. For example, the time period is specific, such as the digital asset can be bought or sold at or after a predetermined time and/or date in the future. As another example, the time period includes a range, such as the digital asset can be bought and/or sold during predetermined dates and times. As another example, the time period sets a holding period or amount of time during which a buyer can or cannot sell the digital asset after purchasing it. One or more smart contracts store these time periods and code to execute and enforce them.

Block 310 makes a determination as to whether the time period expired.

If the answer to this determination is yes, flow proceeds to block 320 that states allow the sale of the digital asset.

If the answer to this determination is no, then flow proceeds to block 330 that states deny the sale of the digital asset. Flow loops back to block 310.

Consider an example in which code in the smart contract governs whether the digital asset can be sold based on time. For example, the smart contract receives date and time information before deciding whether to grant or deny the sale of the digital asset, minting of the digital asset, and/or transfer of ownership of the digital asset.

Consider an example in which code in the smart contract includes an exclusion period that states the digital asset cannot be sold or ownership transferred for a period of time after each sale and/or ownership transfer. For instance, a seller sells an NFT on an electronic marketplace. Ownership of the NFT transfers to a buyer, and the blockchain stores the public address of the buyer. Thereafter, the NFT cannot be sold for a set or predetermined time, such as one hour, twelve hours, one day, two days, three days, four days, five days, one week, two weeks, three weeks, or one month. If the buyer attempts to sell the NFT during this exclusion period, the smart contract will prohibit the sale and/or transfer of ownership from the public address of the buyer. This action prevents buyers from buying digital assets, such as NFTs, and immediately flipping them.

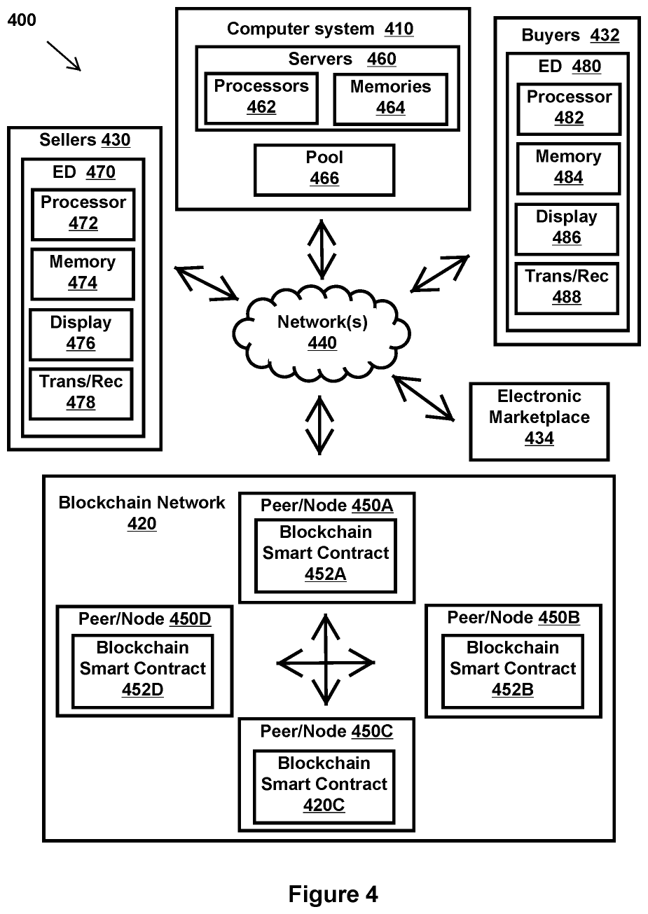

FIG. 4 is an electronic or computer system 400 in accordance with an example embodiment.

The computer system 400 includes a computer system 410, a blockchain network 420, users and/or sellers 430 with electronic devices (ED) 470, users and/or buyers 432 with electronic devices (ED) 480, and one or more electronic marketplaces 434 connected to and/or in communication with one or more networks 440.

The blockchain network 420 includes a plurality of peers, nodes, or electronic devices 450A-450D with each peer having a blockchain and/or smart contract 452A-452D. The blockchain network 420 can include one or more blockchain networks, such as a private blockchain network, a public blockchain network, and a consortium blockchain network.

A smart contract is a computer program that executes transactions on a blockchain. For example, the smart contract is a type of self-executing contract in which the terms and conditions of the transaction or agreement are written into lines of code. The code and accompanying agreement are decentralized and distributed in the blockchain network. By way of example, the Ethereum blockchain uses smart contracts to execute code that add data to the blockchain and perform other functions discussed herein.

A node is a computer that stores a copy of transactions to a blockchain. For example, nodes on a blockchain communicate with each other and exchange data so each node includes a full or partial copy of the transactions of the blockchain. Different types of blockchain nodes exist, such as a full node or validating node, a listening node or super node, and a miner node. A full node verifies transactions and blocks against consensus rules. Full nodes relay new transactions and blocks to the blockchain. Full nodes may have a full copy of the transaction history of the blockchain or a reduced copy of the transaction history (e.g., a light node). A listening node provides information to other nodes and functions as a redistribution point. For example, a listening node transmits blockchain history and transaction data to multiple nodes around the world. A miner node solves mathematical puzzles (proof-of-work) and add transactions to the blockchain. A miner node can also be a node that adds transactional data to the blockchain. Nodes can operate under a proof-of-work (PoW) or proof-of-stake (PoS) protocol.

The blockchain includes a growing list of records (called blocks) that are linked together using cryptography. For example, each block includes a cryptographic hash of the previous block, a timestamp, and transaction data. Examples of a blockchain include the Ethereum blockchain, the Bitcoin blockchain, and many others.

The computer system 410 includes one or more servers 460 with processors 462, memories 464 storing code, and one or more pools 466. The memories store code and the processors execute the code to perform one or more methods in accordance with example embodiments. For example, memories 464 include code stored as smart contracts that execute one or more example embodiments.

The pool 466 includes digital assets, cryptocurrencies, NFTs, and/or tokens that generate a passive income for the sellers and/or buyers of the digital assets. For example, the pool receives cryptocurrency from the sale of the digital assets from the electronic marketplace 434 and then generates income from lending this cryptocurrency, swapping this cryptocurrency, investing this cryptocurrency, charging transaction fees, etc. The computer system 410 pays this income to the sellers 430 and/or buyers 432 as passive income.

The networks 440 include one or more of the following: a cellular network, a public switch telephone network, the Internet, a local area network (LAN), a wide area network (WAN), a metropolitan area network (MAN), a personal area network (PAN), home area network (HAM), blockchain network(s), and other public and/or private networks. Additionally, the electronic devices need not communicate with each other through a network. As one example, electronic devices couple together via one or more wires, such as a direct wired-connection. As another example, electronic devices communicate directly through a wireless protocol, such as Bluetooth, near field communication (NFC), or other wireless communication protocol.

The electronic devices 470 of the sellers 430 include one or more processors 472, memory 474, display 476, and transmitter and/or receiver 478 that wirelessly communicate with the network 440. The electronic devices 480 of the buyers 432 include one or more processors 482, memory 484, display 486, and transmitter and/or receiver 488 that wirelessly communicate with the network 440. The memories 474 and 484 store code that the processors 472 and 482 execute to perform one or more example embodiments.

The electronic devices include, but are not limited to, handheld portable electronic devices (HPEDs), wearable electronic glasses, electronic or smart watches, wearable electronic devices (WEDs), smart earphones or hearables, electronic devices with cellular or mobile phone capabilities or subscriber identification module (SIM) cards, desktop computers, portable computers (such as tablet and notebook computers), smartphones, head mounted displays (HMDs), optical head mounted displays (OHMDs), headphones, and other electronic devices with a processor or processing unit, and a memory.

Non-Fungible Tokens or NFTs are one type of cryptographic tokens on a blockchain that represent a unique digital asset in accordance with an example embodiment. NFTs include unique information and are non-fungible or not mutually interchangeable. Although multiple NFTs can be minted or produced to represent a same object, NFTs differ from each other since they contain unique identification codes and metadata. NFTs differ from fungible tokens, such as cryptocurrencies or coins that are identical to each other.

NFTs are based on a blockchain, which is a digital ledger of transactions duplicated and distributed across a network of computers. Each block in the blockchain includes a record of transactions. Each block includes a cryptographic hash of the previous block, a timestamp, and transaction data. Each time a new transaction occurs on the blockchain, the record for this transaction is added to the ledger. As such, a blockchain is a decentralized, distributed digital ledger in which records or blocks record transactions across many computers. A single block in the chain cannot be altered retroactively without altering all subsequent blocks since each block includes a hash of the previous block.

Consider an example in which each sale of a digital token records a timestamp on the blockchain of the date and time of the sale, an amount of the sale, an address of the seller, and an address of the buyer. Thereafter, an example embodiment queries the blockchain to determine this information, compares the current date and time and calculates the length of time the buyer or owner owned the digital asset. This information enables the smart contract to determine whether a subsequent sale is governed according to an exclusion or restriction, such as a time period, sale price, etc.

A blockchain can be managed with a peer-to-peer (P2P) network as a distributed ledger. Peers in this network follow a predetermined protocol for inter-node communication in order to validate the addition of a new block to the blockchain.

Each node in the network includes a copy of the blockchain with no single copy being an official or trusted copy over another copy. Transactions broadcast to the nodes in the network with timestamps. The P2P network has no central point of failure and hence lacks a single point of attack from a hacker.

Electronic marketplaces, such as electronic marketplace 434, provide online platforms where users can buy, sell, and trade digital or cryptographic assets on a blockchain, such as tokens, NFTs, and other digital assets.

Three categories of income include active income, portfolio income, and passive income. Active income includes earnings from services rendered for a task or job, such salaries, tips, or fees earned from a full-time or part-time job. Passive income includes earnings received when there is little or no ongoing effort. For example, passive income includes income derived from a digital asset in which the owner of the digital asset is not actively involved.

Consider an example embodiment in which an artist or musician mints or tokenizes of a digital asset into an NFT. The owner sells the NFT to a purchaser who buys the NFT for two financial reasons. First, the owner hopes the NFT will appreciate over time so the owner can sell the NFT in the future for a price higher than the purchase price. Second, the owner receives passive income generated from a pool while owning the NFT. This passive income is paid, for example, on an hourly, daily, or weekly basis to the owner as long as the owner owns the NFT.

A smart contract is a program written on top of the blockchain and includes code that automatically executes by nodes in the blockchain network to enforce the terms of the digital asset. The smart contract includes programmatically-executed transactions (PETs) or computer scripts that execute when triggered by a particular message. Each node in the blockchain network verifies the terms of the smart contract. When the terms or rules of the smart contract are satisfied, the agreement executes or is enforced per the terms. For example, code of the smart contract executes one or more blocks in FIGS. 1-3.

Consider an example embodiment of a method and/or apparatus that executes code as a method. The method generates passive income to sellers and buyers of non-fungible tokens (NFTs). The method includes selling, by computers or a computer system and for cryptocurrency, the NFTs from the sellers to the buyers. The method further includes depositing, by the computers or the computer system, the cryptocurrency from the selling of the NFTs into a lending pool executing with smart contracts on a blockchain that lends the cryptocurrency to borrowers and receives income from the borrowers for borrowing the cryptocurrency. The lending pool executes code in the smart contracts to disperse the income generated at the lending pool for the NFTs as passive income into addresses on the blockchain of both the sellers of the NFTs and the buyers of the NFTs.

Consider further this example method that includes storing, on the blockchain, code that fixes a sale price for the NFTs so that each subsequent sale of the NFTs increases by percentage, such as five percent (5%), ten percent (10%), fifteen percent (15%), or twenty percent (20%).

Consider further this example method that includes storing, on the blockchain, code that fixes a minimum duration of time for how long the buyers of the NFTs must hold the NFTs before selling the NFTs.

Consider further this example method that includes displaying, on a body of the NFTs, a visual indication that signifies the buyers of the NFTs will receive the passive income from the lending pool. For example, this visual indication includes words, letters, symbols, or indicia that visually notify the user that the NFT pays passive income. Upon seeing this visual indication, the user knows that this NFT pays passive income.

Consider further this example method that includes displaying, on a body of the NFTs, a visual indication that signifies the buyers of the NFTs cannot sell the NFTs for a fixed period of time after purchasing the NFTs. For example, this visual indication includes words, letters, symbols, or indicia that visually notify the user that the NFT cannot be sold within a given time period or during an exclusion period. Upon seeing this visual indication, the user knows that this NFT cannot be sold until the time period expires. This visual indication can include the date and/or time of this time period.

Consider further this example method that includes continuing to disperse the income from the lending pool as the passive income into the addresses on the blockchain of the buyers of the NFTs as long as the buyers are owners of the NFTs.

Consider further this example method that includes discontinuing to disperse the income from the lending pool as the passive income into the addresses on the blockchain of the buyers of the NFTs when the buyers sell the NFTs.

Consider an example embodiment of a method and/or apparatus that executes code as a method. The method provides passive income to a seller and a buyer of a non-fungible token (NFT). The method includes receiving, at a lending pool executing with smart contracts on a blockchain, cryptocurrency from an electronic marketplace that executed a sale of the NFT from the seller to the buyer. The lending pool lends the cryptocurrency to borrowers who pay an interest rate for borrowing the cryptocurrency and disperses the interest rate received from the borrowers to the seller of the NFT and to the buyer of the NFT.

In this example, the cryptocurrency received from the buyer to purchase the NFT goes into the lending pool which pays passive income to both the buyer of the NFT and the seller who sold the NFT to the buyer. The seller owns the cryptocurrency, and the buyer owns the NFT. Passive income from the sale of the NFTs is paid to the buyer as an incentive for the buyer to hold and not sell the NFT. This reduces occurrences of flipping the NFT and provides market and price stability for the NFT since buyers have a financial incentive to hold the NFT long term.

Consider further this example method that includes ceasing, by the lending pool, to disperse the interest rate received from the borrowers as the passive income to the buyer of the NFT in response to the buyer selling the NFT to another buyer, but maintaining dispersion of the passive income to the seller.

Consider further this example method that includes continuing, by the lending pool, to disperse the interest rate received from the borrowers as the passive income to the buyer of the NFT as long as the buyer owns the NFT.

Consider further this example method that includes storing, on the blockchain, a transaction record when the buyer sells the NFT to a second buyer; and dispersing, by the lending pool, the interest rate received from the borrowers to the second buyer of the NFT in response to the buyer selling the NFT to the second buyer.

Consider further this example method that includes depositing one hundred percent (100%) of the cryptocurrency received from the selling of the NFTs into the lending pool.

Consider further this example method that includes receiving, from the borrowers of the cryptocurrency and at the lending pool, the income as interest rate payments for borrowing the cryptocurrency; and dispersing one hundred percent (100%) of the income as the interest rate payments from the borrowers for borrowing the cryptocurrency to the buyers of the NFTs.

Consider further this example method that includes receiving, from the borrowers of the cryptocurrency and at the lending pool, liquidation fees when a collateral ratio of collateral provided by the borrowers reaches a predetermined amount; and dispersing one hundred percent (100%) of the liquidation fees to the sellers of the NFTs and the buyers of the NFTs.

Consider an example embodiment of a method and/or apparatus that executes code as a method. The method reduces price volatility of non-fungible tokens (NFTs) and includes receiving, at a lending pool executing on a blockchain and from an electronic marketplace, cryptocurrency received from selling the NFTs to buyers. The method further includes loaning, by the lending pool, the cryptocurrency received from selling the NFTs to borrowers of the cryptocurrency and receiving, by the lending pool and from the borrowers of the cryptocurrency, payments as an interest rate for borrowing the cryptocurrency received from the selling of the NFTs. The lending pool pays the payments received from the borrowers of the cryptocurrency to the buyers of the NFTs as passive income.

Consider further this example method that includes ceasing, by the lending pool, the paying of the payments to the buyers of the NFTs in response to the buyers selling the NFTs while maintaining payments of the passive income to sellers of the NFTs.

Consider further this example method that includes recording, on the blockchain, a transfer of ownership of the NFTs from the buyers to other buyers; and changing, by the lending pool, the payments from being provided to the buyers of the NFTs to the other buyers of the NFTs in response to the transfer of ownership of the NFTS from the buyers to the other buyers.

Consider further this example method that includes coding, with smart contracts on the blockchain, a fixed amount of profit the buyers can make upon selling the NFTs to other buyers.

Consider further this example method that includes coding, with smart contracts on the blockchain, a fixed amount of loss the buyers can make upon selling the NFTs to other buyers.

Consider further this example method that includes establishing, with smart contracts on the blockchain, a price range that governs how much of the cryptocurrency the NFTs can sell for in any sale of the NFTs.

Consider further this example method that includes establishing, with smart contracts on the blockchain, a minimum price and a maximum price that govern a price at which the NFTs can be sold for any sale that occurs after the NFTs are minted and sold at the electronic marketplace.

Memory in the electronic devices includes computer readable medium (CRM) that stores code and/or instructions to execute one or more example embodiments. Memory in nodes also stores one or more of the blockchain and smart contracts.

The processor includes one or more of a central processing unit (CPU), digital signal processor (DSP), graphics processing unit (GPU), microprocessor, microcontrollers, field programmable gate arrays (FPGA), application-specific integrated circuits (ASIC), etc. for controlling the overall operation of memory (such as random-access memory (RAM) for temporary data storage, read only memory (ROM) for permanent data storage, and firmware). The processor communicates with the memory and other electronic components to perform operations and tasks that implement one or more blocks of the flow diagram discussed herein. The memory, for example, stores applications, data, programs, algorithms (including software to implement or assist in implementing example embodiments) and other data.

In some example embodiments, the methods illustrated herein and data and instructions associated therewith, are stored in respective storage devices that are implemented as computer-readable and/or machine-readable storage media, physical or tangible media, and/or non-transitory storage media. These storage media include different forms of memory including semiconductor memory devices such as DRAM, or SRAM, Erasable and Programmable Read-Only Memories (EPROMs), Electrically Erasable and Programmable Read-Only Memories (EEPROMs) and flash memories; magnetic disks such as fixed and removable disks; other magnetic media including tape; optical media such as Compact Disks (CDs) or Digital Versatile Disks (DVDs). Note that the instructions of the software discussed above can be provided on computer-readable or machine-readable storage medium, or alternatively, can be provided on multiple computer-readable or machine-readable storage media distributed in a large system having possibly plural nodes, such as nodes or computers on a blockchain. Example embodiments include code stored on one or more blockchains and/or nodes and executed as one or more smart contracts. Such computer-readable or machine-readable medium or media is (are) considered to be part of an article (or article of manufacture). An article or article of manufacture can refer to a manufactured single component or multiple components.

Blocks and/or methods discussed herein can be executed and/or made by a user, a user agent (including machine learning agents and intelligent user agents), a software application, an electronic device, a computer, firmware, hardware, a process, a computer system, one or more smart contracts, and/or an intelligent personal assistant. Furthermore, blocks and/or methods discussed herein can be executed automatically with or without instruction from a user.

What is claimed is:

1. A method that generates passive income to sellers and buyers of non-fungible tokens (NFTs), the method comprising:
selling, by computers and for cryptocurrency, the NFTs from the sellers to the buyers;
depositing, by the computers, the cryptocurrency from the selling of the NFTs into a lending pool executing with smart contracts on a blockchain that lends the cryptocurrency to borrowers and receives income from the borrowers for borrowing the cryptocurrency; and
dispersing, by the lending pool executing with the smart contracts, the income generated at the lending pool for the NFTs as passive income into addresses on the blockchain of both the sellers of the NFTs and the buyers of the NFTs.

2. The method of claim 1 further comprising:
storing, on the blockchain, code that fixes a sale price for the NFTs so that each subsequent sale of the NFTs increases by ten percent (10%).

3. The method of claim 1 further comprising:
storing, on the blockchain, code that fixes a minimum duration of time for how long the buyers of the NFTs must hold the NFTs before selling the NFTs.

4. The method of claim 1 further comprising:
displaying, on a body of the NFTs, a visual indication that signifies the buyers of the NFTs will receive the passive income from the lending pool.

5. The method of claim 1 further comprising:
displaying, on a body of the NFTs, a visual indication that signifies the buyers of the NFTs cannot sell the NFTs for a fixed period of time after purchasing the NFTs.

6. The method of claim 1 further comprising:
continuing to disperse the income from the lending pool as the passive income into the addresses on the blockchain of the buyers of the NFTs as long as the buyers are owners of the NFTs; and
discontinuing to disperse the income from the lending pool as the passive income into the addresses on the blockchain of the buyers of the NFTs when the buyers sell the NFTs.

7. A non-transitory computer-readable storage medium storing code that one or more electronic devices execute as a method that provides passive income to a seller and a buyer of a non-fungible token (NFT), the method comprising:
receiving, at a lending pool executing with smart contracts on a blockchain, cryptocurrency from an electronic marketplace that executed a sale of the NFT from the seller to the buyer;
lending, from the lending pool, the cryptocurrency to borrowers who pay an interest rate for borrowing the cryptocurrency; and
dispersing, by the lending pool, the interest rate received from the borrowers to the seller of the NFT and to the buyer of the NFT.

8. The non-transitory computer-readable storage medium storing the code of claim 7 in which the method further comprises:
ceasing, by the lending pool, to disperse the interest rate received from the borrowers as the passive income to the buyer of the NFT in response to the buyer selling the NFT to another buyer, but maintaining dispersion of the passive income to the seller.

9. The non-transitory computer-readable storage medium storing the code of claim 7 in which the method further comprises:
continuing, by the lending pool, to disperse the interest rate received from the borrowers as the passive income to the buyer of the NFT as long as the buyer owns the NFT.

10. The non-transitory computer-readable storage medium storing the code of claim 7 in which the method further comprises:
storing, on the blockchain, a transaction record when the buyer sells the NFT to a second buyer; and
dispersing, by the lending pool, the interest rate received from the borrowers to the second buyer of the NFT in response to the buyer selling the NFT to the second buyer.

11. The non-transitory computer-readable storage medium storing the code of claim 7 in which the method further comprises:
depositing one hundred percent (100%) of the cryptocurrency received from the selling of the NFTs into the lending pool.

12. The non-transitory computer-readable storage medium storing the code of claim 7 in which the method further comprises:
receiving, from the borrowers of the cryptocurrency and at the lending pool, the income as interest rate payments for borrowing the cryptocurrency; and
dispersing one hundred percent (100%) of the income as the interest rate payments from the borrowers for borrowing the cryptocurrency to the buyers of the NFTs.

13. The non-transitory computer-readable storage medium storing the code of claim 7 in which the method further comprises:
receiving, from the borrowers of the cryptocurrency and at the lending pool, liquidation fees when a collateral ratio of collateral provided by the borrowers reaches a predetermined amount; and
dispersing one hundred percent (100%) of the liquidation fees to the sellers of the NFTs and the buyers of the NFTs.

14. A method that reduces price volatility of non-fungible tokens (NFTs), the method comprising:
receiving, at a lending pool executing on a blockchain and from an electronic marketplace, cryptocurrency received from selling the NFTs to buyers;
loaning, by the lending pool, the cryptocurrency received from selling the NFTs to borrowers of the cryptocurrency;
receiving, by the lending pool and from the borrowers of the cryptocurrency, payments as an interest rate for borrowing the cryptocurrency received from the selling of the NFTs; and
paying, by the lending pool, the payments received from the borrowers of the cryptocurrency to the buyers of the NFTs as passive income.

15. The method of claim 14 further comprising:
ceasing, by the lending pool, the paying of the payments to the buyers of the NFTs in response to the buyers selling the NFTs while maintaining payments of the passive income to sellers of the NFTs.

16. The method of claim 14 further comprising:
recording, on the blockchain, a transfer of ownership of the NFTs from the buyers to other buyers; and
changing, by the lending pool, the payments from being provided to the buyers of the NFTs to the other buyers of the NFTs in response to the transfer of ownership of the NFTS from the buyers to the other buyers.

17. The method of claim 14 further comprising:
coding, with smart contracts on the blockchain, a fixed amount of profit the buyers can make upon selling the NFTs to other buyers.

18. The method of claim 14 further comprising:
coding, with smart contracts on the blockchain, a fixed amount of loss the buyers can make upon selling the NFTs to other buyers.

19. The method of claim 14 further comprising:
establishing, with smart contracts on the blockchain, a price range that governs how much of the cryptocurrency the NFTs can sell for in any sale of the NFTs.

20. The method of claim 14 further comprising:
establishing, with smart contracts on the blockchain, a minimum price and a maximum price that govern a price at which the NFTs can be sold for any sale that occurs after the NFTs are minted and sold at the electronic marketplace.
